(19) United States
(12) Patent Application Publication
(10) Pub. No.: US 2012/0134164 A1
(43) Pub. Date: May 31, 2012

(54) APPARATUS AND METHOD FOR CONTROLLING HEAD LAMP FOR VEHICLES

(75) Inventors: Jong Ryoul Park, Gyeongsan (KR); Young Ho Son, Gyeongsan (KR); Jae Gun Lee, Gyeongsan (KR)

(73) Assignee: SL CORPORATION, Daegu (KR)

(21) Appl. No.: 13/277,858

(22) Filed: Oct. 20, 2011

(30) Foreign Application Priority Data
Nov. 25, 2010 (KR) 10-2010-0118070

(51) Int. Cl. B60Q 1/04

(52) U.S. Cl. 362/464

(57) ABSTRACT

An apparatus for controlling a head lamp for vehicles which includes an image providing unit which acquires image information in front of a subject vehicle through a camera module and an information processing unit which detects a position of a vehicle in front of the subject vehicle based on the image information to determine a high beam avoidance area. In particular, a light source unit irradiates a high beam and a low beam in the head lamp based on the driving information acquired. In particular, the high beam avoidance area is represented by an angular range, and is within a range of 90 degrees with respect to a forward direction of the subject vehicle, and the angular range of the high beam avoidance area is determined based on outermost vehicles on left and right sides in the image information.

### CROSS-REFERENCE TO RELATED APPLICATION

This application claims priority from Korean Patent Application No. 10-2010-0118070 filed on Nov. 25, 2010, and all the benefits accruing therefrom under 35 U.S.C. 119, the contents of which in its entirety are herein incorporated by reference.

### BACKGROUND

1. Field of the Invention

The present invention relates to an apparatus and method for controlling a head lamp for vehicles, and more particularly to an apparatus and method for controlling a head lamp for vehicles to automatically control a high beam according to whether there is a vehicle ahead.

2. Description of the Related Art

In general, a vehicle includes lamps having a lighting function for enabling a driver to easily recognize objects around the vehicle at night and a signaling function for informing a driver of another vehicle or a pedestrian of a driving state of the vehicle. For example, a head lamp and a fog light are used to provide a lighting function, and a blinker, a tail lamp, a stop lamp and a side marker are used to provide a signaling function.

In a case where the vehicle is traveling at night or in a tunnel with low luminance, the driver can recognize objects in front of or behind his/her own vehicle by light irradiated from a light source used in a front lamp or rear lamp, thereby enabling safe driving. In this case, the vehicle lamp includes an optical functional body and a plurality of reflective surfaces in order to appropriately diffuse the light emitted from the light source, or polarize or condense the refracted light to be directed forward.

Recently, many studies are being conducted on a technique for ensuring the driver's view by controlling a light irradiation direction of a head lamp for vehicles on the basis of driving information of the vehicle, e.g., a driving speed of the vehicle or a rotation angle of wheels. For example, the vehicle may have sensors for detecting the driving information of the vehicle, i.e., a driving speed of the vehicle, a rotational angle of wheels, the horizontality of the vehicle and the like. The detection results of the sensors are transmitted to an electronic control unit, and the electronic control unit controls the light irradiation direction of the head lamp based on the detection results of the sensors.

Particularly, recently, there is an increasing demand for safety to enable safer driving. It requires a technique for ensuring the driver's view even when it is difficult to ensure a forward vision, for example, when the vehicle is moving from a linear road to a curved road and vice versa at night, or when there are crossroads in front of the vehicle at night. Accordingly, there has been proposed a system for automatically controlling a head lamp for vehicles, e.g., an adaptive front-light system (AFLS) for ensuring the driver's view by acquiring road environment information through an image of the road in front of the vehicle and rotating the head lamp according to the road environment information to control the light irradiation direction.

For example, as shown in FIGS. 1 and 2, in a case where the vehicle is traveling on a steep and curved road at night, the vehicle may be traveling with a high beam turned on. The high beam contributes to ensuring the driver's field of view, but may cause glare to another driver of an on-coming vehicle in an opposite lane or a preceding vehicle to disturb the driver's view, thereby instantaneously increasing the probability of an accident. Accordingly, it is necessary to appropriately control the high beams in a vehicle to avoid accidental collisions. That is, although the vehicle is moving with the high beam turned on, if there is a vehicle travelling in front of or in an opposing lane of the vehicle with its high beams on, it is required to control the high beam so as not to disturb another driver's view by temporarily turning off the high beam or changing the direction of the high beam manually by the driver.

The same is applied to a linear road as shown in FIGS. 3 and 4. That is, in a case of FIG. 3, although the high beam may not affect the vehicle in the opposing lane, the high beam may affect the preceding vehicle. That is, the driver of the preceding vehicle may make a driving error due to glare or the like, and thus increase the risk of an accident. On the other hand, in a case of FIG. 4, although the high beam may not affect the preceding vehicle, the high beam does directly affect the vehicle in the opposing lane, the driver of the vehicle in the opposing lane may make a mistake a driving error due to glare or the like.

In these situations, it is necessary to appropriately control the high beams in the vehicle manually by the driver. However, in a case where a preceding or vehicle in the opposite lane frequently passes in front of the vehicle, the driver must repetitively and continuously turn on and off of the high beams manually, which distracts the attention of the driver and reduces their concentration during driving due to an operation of the high beam. Accordingly, it increases the risk of accidents.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an apparatus and method for controlling a head lamp for vehicles to automatically control a high beam without an operation of a driver if there is another vehicle ahead by analyzing image information in front of a subject vehicle acquired while the subject vehicle is traveling with the high beam turned on.

The present invention also provides an apparatus and method for controlling a head lamp for vehicles to automatically control a high beam without an operation of a driver while a subject vehicle is traveling with the high beam turned on, and to ensure a driver's view of the subject vehicle at a maximum level by controlling the high beam so as not to disturb the vision of another driver of a preceding vehicle or an on-coming vehicle, thereby enabling a safe driving experience.

The objects of the present invention are not limited thereto, and the other objects of the present invention will be described in or be apparent from the following description of the embodiments.

In the apparatus and method for controlling a head lamp for vehicles in accordance with embodiments of the present invention, it is possible to automatically control a high beam without an operation of a driver if there is another vehicle ahead by analyzing image information in front of a subject vehicle acquired while the subject vehicle is traveling with the high beams turned on. Further, it is possible to automatically control a high beam without an operation of a driver while a subject vehicle is traveling with the high beam turned on, and to ensure a driver's view of the subject vehicle at a maximum level by controlling the high beam so as not to disturb the vision of another driver of a preceding vehicle or an on-coming vehicle, thereby enabling safe driving. The effects of the present invention, however, are not limited thereto, and various effects of the present invention can be apparently understood from the following description.

According to an aspect of the present invention, there is provided an apparatus for controlling a head lamp for vehicles. In particular, an image providing unit in configured to acquire image information in front of a subject vehicle through a camera module and an information processing unit is configured to detect a position of a vehicle in front of the subject vehicle based on the image information to determine a high beam avoidance area. A light source unit irradiates a high beam and a low beam in the head lamp, wherein the high beam avoidance area is represented by an angular range, and is within a range of 90 degrees with respect to a forward direction of the subject vehicle, and the angular range of the high beam avoidance area is determined based on outermost vehicles on left and right sides in the image information.

According to another aspect of the present invention, there is provided a method for controlling a head lamp for vehicles which includes acquiring image information in front of a subject vehicle through a camera module; determining a high beam avoidance area by detecting a position of a vehicle in front of the subject vehicle based on the image information; and blocking some or all of a high beam in the head lamp corresponding to the high beam avoidance area, wherein the high beam avoidance area is represented by an angular range, and is within a range of 90 degrees with respect to a forward direction of the subject vehicle, and the angular range of the high beam avoidance area is determined based on outermost vehicles on left and right sides in the image information.

### BRIEF DESCRIPTION OF THE DRAWINGS

The above and other aspects and features of the present invention will become more apparent by describing in detail exemplary embodiments thereof with reference to the attached drawings, in which:

FIGS. 1 and 2 illustrate a high beam irradiation area in a curved road in a conventional apparatus for controlling a head lamp;

FIGS. 3 and 4 illustrate a high beam irradiation area in a linear road in the conventional apparatus for controlling a head lamp;

FIG. 5 shows a configuration of an apparatus for controlling a head lamp in accordance with an exemplary embodiment of the present invention;

FIG. 6 illustrates a camera detection area of the apparatus for controlling a head lamp in accordance with the exemplary embodiment of the present invention;

FIG. 7 illustrates a high beam avoidance area and a high beam irradiation area of the apparatus for controlling a head lamp in accordance with the exemplary embodiment of the present invention;

FIG. 8 illustrates image information of the apparatus for controlling a head lamp of FIG. 7;

FIGS. 9 to 12 illustrate the high beam avoidance area and the high beam irradiation area of the apparatus for controlling a head lamp in various road situations in accordance with the exemplary embodiment of the present invention;

FIG. 13 illustrates a structure of the head lamp of the apparatus for controlling a head lamp in accordance with the exemplary embodiment of the present invention;

FIGS. 14 and 15 illustrate a high beam irradiation direction and irradiation area according to the position of a light blocking unit of the apparatus for controlling a head lamp in accordance with the exemplary embodiment of the present invention;

FIG. 16 illustrates a method for controlling a head lamp in accordance with the exemplary embodiment of the present invention; and

FIG. 17 is a flowchart showing a process of setting the high beam avoidance area in the method for controlling a head lamp in accordance with the exemplary embodiment of the present invention.

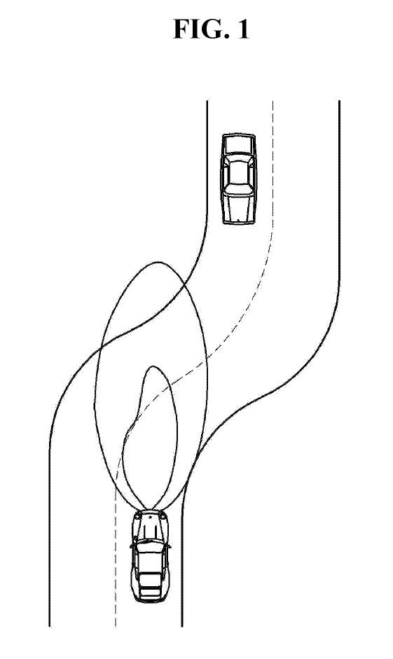

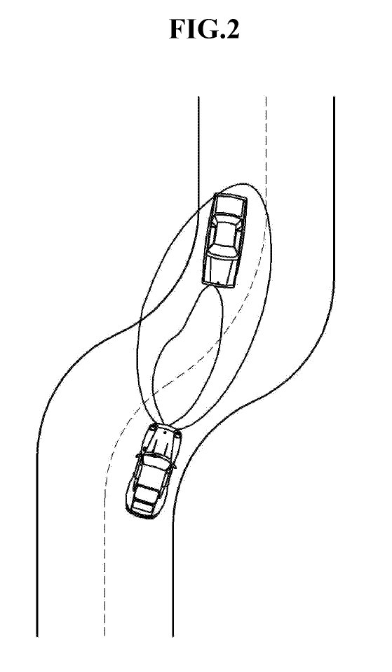

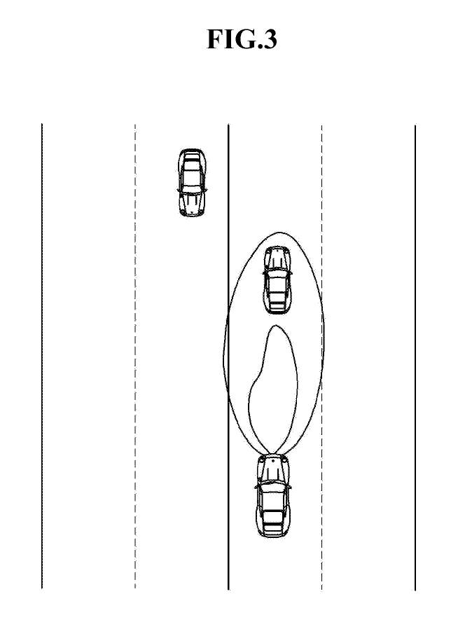

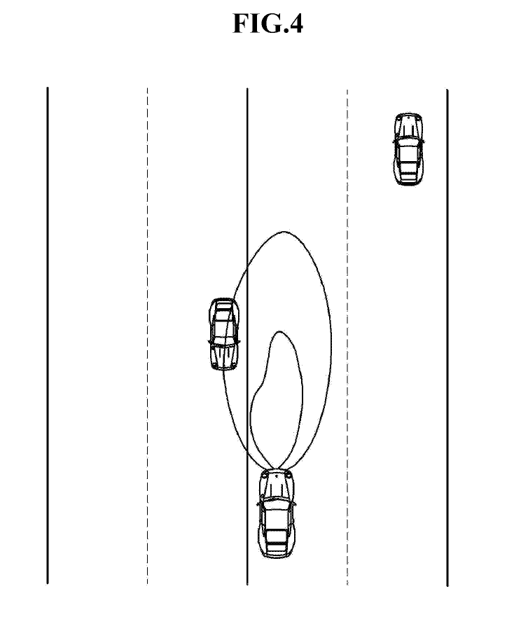

### DETAILED DESCRIPTION OF THE DISCLOSURE

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

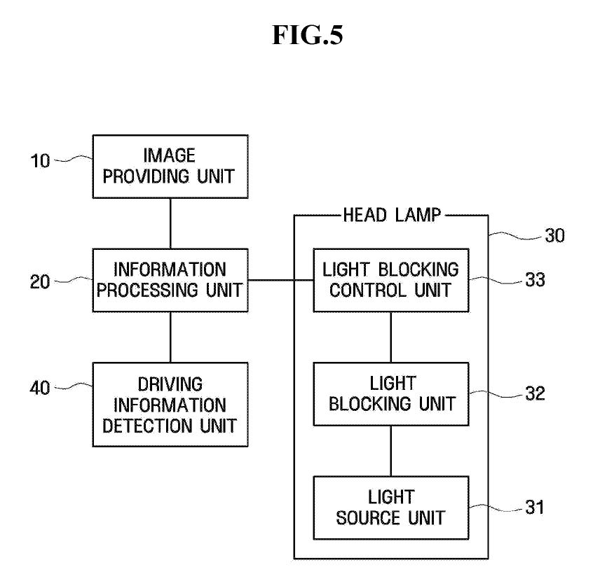

FIG. 5 shows a configuration of an apparatus for controlling a head lamp in accordance with an embodiment of the present invention. The apparatus for controlling a head lamp in accordance with the embodiment of the present invention includes an image providing unit 10 which acquires image information in front of a subject vehicle through a camera module, an information processing unit 20 which detects a position of a vehicle in front of the subject vehicle based on the image information to determine a high beam avoidance area, and a head lamp 30 which illuminates a target area in front of the subject vehicle. The head lamp 30 includes a light source unit 31 which irradiates an high beam and a low beam in the head lamp 30, a light blocking unit 32 which blocks some or all of the high beam irradiated from the light source unit 31 to control the irradiation of the high beam, and a light blocking control unit 33 which determines a position of the light blocking unit 32 corresponding to the high beam avoidance area. The image providing unit 10 includes the camera module acquiring the image information in front of the subject vehicle, and transmits the image information acquired by the camera module to the information processing unit 20.

As described above, the high beam at night contributes to the expansion of a driver's field of view, but may cause glare to other drivers of a vehicle moving in the opposite direction or a vehicle traveling in front of the subject vehicle which in turn disrupts the other driver's view, thereby increasing the probability of an accident. Accordingly, it is necessary to appropriately control the high beams of a vehicle. In the embodiment of the present invention, when analyzing the image information in front of the subject vehicle acquired by the image providing unit 10, if there is a vehicle in front of the subject vehicle with their high beams turned on, it is possible to automatically control the high beams without any operation on the part of the driver. That is, the high beams of the subject vehicle with the high beams turned on are automatically controlled without the operation of the driver so as not to disturb the driver's vision of the preceding vehicle or an on-coming vehicle. Accordingly, it is possible to ensure the driver's view of the subject vehicle at a maximum level while at the same time protecting the vision of other drivers on the road, thereby enabling a safer driving environment.

More specifically, the camera module of the image providing unit 10 may be a camera having a night photographing function to accurately detect the road information of a sharp curve at night when precise control of the head lamp is required. The image providing unit 10 converts the image information in front of the subject vehicle acquired by the camera module into image data, and transmits the image data to the information processing unit 20. The image information may be converted in a compressed format to facilitate the data transmission. The image data in a compressed format may have various well-known forms such as MPEG-1 and MPEG-4, wherein MPEG stands for Moving Picture Experts Group.

The information processing unit 20 extracts front or on-coming road information from the image information in front of the subject vehicle provided from the image providing unit 10 and determines whether there is an on-coming vehicle and/or a preceding vehicle on the road in front of the subject vehicle. If there is an on-coming vehicle or a preceding vehicle on the road in front of the subject vehicle, the information processing unit 20 determines a high beam avoidance area E for avoiding the irradiation of the high beam of the subject vehicle to avoid disturbing the vision of other drivers on the road coming from the opposite direction of the subject vehicle or traveling in front of (preceding) the subject vehicle.

In determining whether there is an on-coming vehicle or a preceding vehicle, the high beam avoidance area E may be configured to be set only when it is determined that there is a vehicle within a predetermined distance from the subject vehicle. The predetermined distance may is defined as a distance which may be affected by the high beam of the subject vehicle. In this case, the high beam avoidance area E may have a slight difference according to the type of subject vehicle, and also have a difference between the on-coming vehicle and the preceding vehicle. For example, in case of the on-coming vehicle, since the on-coming vehicle is moving toward the high beam of the subject vehicle, the distance which may be affected by the high beam of the subject vehicle is larger than that of the preceding vehicle. Generally, the on-coming vehicle may be affected within about 250 m from the subject vehicle, and the preceding vehicle is often only affected within about 150 m from the subject vehicle.

The high beam avoidance area E is defined an area to which the high beam should not be irradiated and is set based on the positions of the preceding vehicle and the on-coming vehicle in front of the subject vehicle. A method of setting the high beam avoidance area E will be described in detail below.

The apparatus for controlling a head lamp in accordance with the embodiment of the present invention may further include a driving information detection unit 40 which detects driving information including a steering angle of the vehicle. The information processing unit 20 may determine the high beam avoidance area E in consideration of the driving information provided from the driving information detection unit 40 in addition to the image information provided from the image providing unit 10. The driving information may further include at least one of a driving speed, a driving direction, and horizontality of the vehicle.

The high beam avoidance area E is set by analyzing the image information provided by the image providing unit 10. In this case, since not only the subject vehicle but also the preceding vehicle and the on-coming vehicle may be moving, the high beam avoidance area E may be set in real time by considering and reflecting the driving speeds and the driving directions of the vehicles.

The head lamp 30 may include first and second head lamps. The high beam avoidance area E may be determined individually in head lamp and the second head lamp respectively. Generally, the head lamp 30 has two left and right head lamps, and the first and second head lamps have different high beam irradiation ranges. Accordingly, the high beam avoidance area E of the first head lamp and the high beam avoidance area E of the second head lamp may be individually determined. The head lamp 30 includes the light source unit 31 which irradiates an high beam and a low beam in the head lamp 30, the light blocking unit 32 which blocks some or all of the high beam irradiated from the light source unit 31 to control the irradiation of the high beam, and the light blocking control unit 33 which determines the position of the light blocking unit 32 corresponding to the high beam avoidance area E.

The light source unit 31 is a light emitting module in the form of a projector, and includes a discharge bulb and a light emitting section which emits light due to the discharge bulb. The discharge bulb is, e.g., a metal halide valve, and the light emitting section directly emits light by discharge illumination. Additionally, the light source unit 31 may include a plurality of light emitting diodes (LEDs). In a case where the light source unit 31 includes a plurality of LEDs capable of being individually controlled, since each LED can be independently turned on and off, a desired light pattern can be easily formed. That is, the desired light pattern may be formed by receiving a signal from the light blocking control unit 33 to turn off an LED at a position corresponding to the high beam avoidance area E and then turning off the corresponding LED. In this case, differently from the light source unit 31 in the form of a projector, the light blocking unit 32 may be omitted in front of the light source unit 31 having the LEDs.

The light blocking unit 32 may be configured to block some of light irradiated from the light source unit 31. In particular, the light source unit 31 generates light and the generated light is reflected by a reflection plate surrounding the light source unit 31 and directed forward. The light may be classified into a high beam directed upward from the head lamp 30 and a low beam directed downward from the head lamp 30. In this case, the light blocking unit 32 allows the low beam to pass therethrough and blocks the high beam, thereby controlling the irradiation of the high beam.

In general, when the driver operates the head lamp 30, since the light blocking unit 32 is set to block the high beam, the high beam is not irradiated. If the driver changes the position of the light blocking unit 32 by operating a lever of the high beam, the light blocking unit 32 blocking the high beam is moved to allow the high beam to pass therethrough. Accordingly, the high beam is irradiated forward from the head lamp 30. As described above, since the high beams disrupt driver's vision in the preceding vehicle or the on-coming vehicle, the high beam are appropriately controlled based on whether there is a preceding vehicle and/or an on-coming vehicle in an avoidance area E in front of the subject vehicle while the driver of the subject vehicle is driving with the high beam turned on. The light blocking unit 32 may be provided in each of the first and second head lamps. Accordingly, the light blocking control unit 33 may control whether to irradiate the high beam and the irradiation direction of the high beam by changing the position of the light blocking unit 32 corresponding to the high beam avoidance area E set by the information processing unit 20.

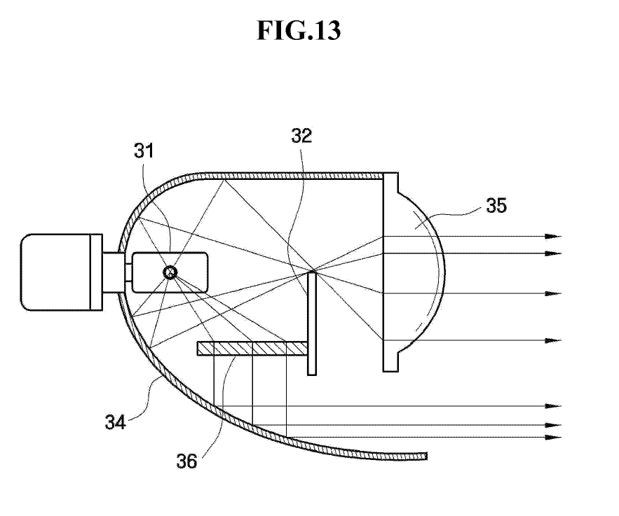

A detailed structure of the head lamp 30 will be described in detail with reference to FIG. 13.

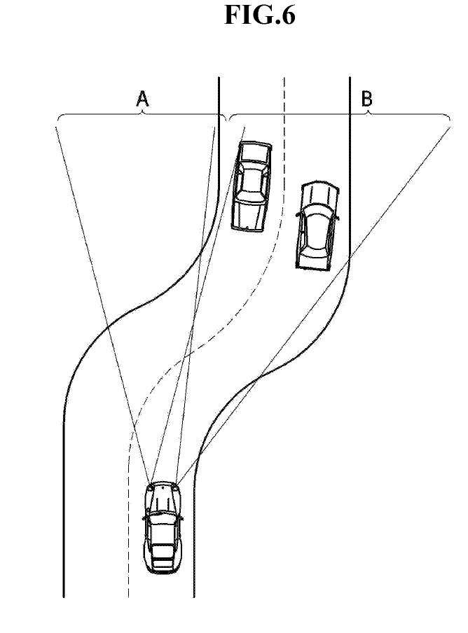

Subsequently, FIG. 6 illustrates a camera detection area of the apparatus for controlling a head lamp in accordance with the embodiment of the present invention. A conventional camera module mounted on the vehicle acquires the image information of the forward view of the vehicle regardless of the speed, rotation rate, and steering angle of the vehicle. However, if a sharp curve having a direction different from the driving direction, e.g., an S-shaped sharp curve, is ahead of the subject vehicle, it is difficult to ensure the forward view of the driver and acquire the information of the preceding vehicle and the on-coming vehicle of the subject vehicle on the S-shaped road.

Particularly, in a case where the high beam is irradiated forward from the subject vehicle in order for the driver to ensure a wider field of view at night, another driver of the on-coming vehicle moving in the opposite direction or the preceding vehicle may have difficulty in ensuring the vision, e.g., instantaneous glare due to an unexpected light source. Since it may cause traffic accidents, it is very dangerous. Accordingly, in order to prevent traffic accidents, the irradiation direction and the like of the high beam is appropriately controlled by the present invention by determining in advance whether there is a vehicle ahead in the sharp curve.

In particular, the camera module of the image providing unit 10 in accordance with the embodiment of the present invention acquires the image information of the road ahead by changing the direction of the camera module in advance according to the shape of the road ahead. That is, while the subject vehicle is traveling on a linear road based on the image information in a forward direction A, if there is a curve ahead, it is possible to appropriately acquire the image information in front of the subject vehicle by changing the direction of the camera module to a curve direction B in advance. Accordingly, it is possible to appropriately block the high beam by calculating the high beam avoidance area E by detecting whether there is a preceding vehicle and/or an on-coming vehicle on the road and the position thereof in advance, and changing the position of the light blocking unit 32 before entering the curve.

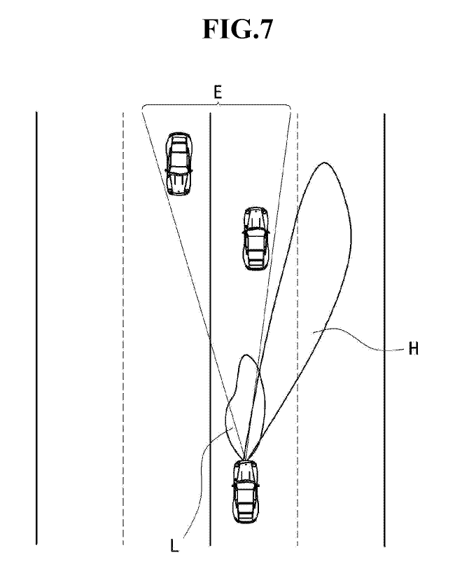

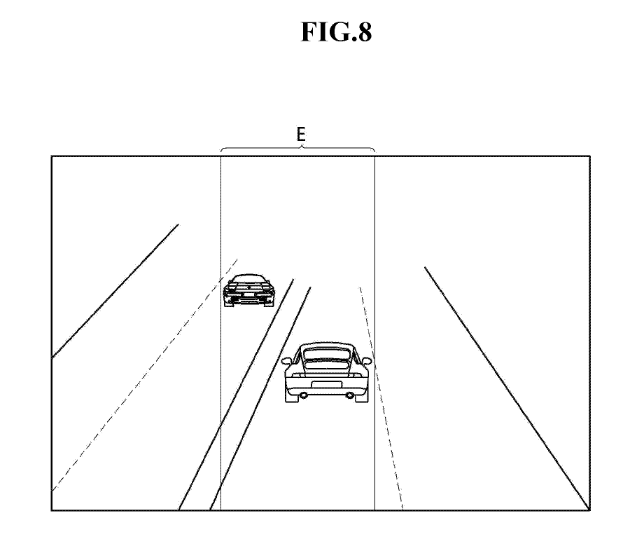

Subsequently, FIG. 7 illustrates the high beam avoidance area and a high beam irradiation area of the apparatus for controlling a head lamp in accordance with the illustrative embodiment of the present invention. FIG. 8 illustrates the image information of the apparatus for controlling a head lamp of FIG. 7.

First, the information processing unit 20 determines the high beam avoidance area E based on the image information in front of the subject vehicle acquired by the image providing unit 10. The high beam avoidance area E may be represented by an angular range and may be within a range of 90 degrees with respect to the forward direction of the subject vehicle.

A remaining area, except for the high beam avoidance area E, in a whole range in which the high beam can be irradiated corresponds to a high beam irradiation area H. As described above, the light irradiated from the head lamp 30 may be classified into a high beam and a low beam by a middle boundary of an illumination area. Since the low beam does not particularly affect the driver's vision of the preceding vehicle or the on-coming vehicle, a low beam irradiation area L is uniformly maintained all the time.

The angular range of the high beam avoidance area E is determined based on the outermost vehicles on the left and right in the image information. Further, it includes detailed information of the outermost vehicles in the high beam avoidance area E, e.g., the information regarding the widths of the vehicles, distances between the subject vehicle and the outermost vehicles and specific angles. For example, if there is one preceding vehicle and one on-coming vehicle as illustrated in FIG. 7, supposing that a right direction of the subject vehicle is zero and a left direction of the subject vehicle is 180 degrees with respect to a forward direction of the subject vehicle of 90 degrees serving as a reference line, the high beam avoidance area E in FIG. 7 is set within a range of about 80 to 135 degrees. Accordingly, the high beam irradiation area H is set as a remaining area except for the high beam avoidance area E. The high beam irradiation area H is depicted in only a right portion of FIG. 7. This is because the high beam avoidance area E of the left side is larger, and all of the left high beam irradiation area of the whole high beam irradiation area is set as the high beam avoidance area E. As described above, the whole high beam irradiation area may be changed according to the type of the vehicle or the type of the head lamp 30.

FIG. 8 schematically shows the image information of the apparatus for controlling a head lamp of FIG. 7, which is actually the image information received by the information processing unit 20. First, the information processing unit 20 determines whether there are preceding and on-coming vehicles in front of the subject vehicle based on the image information provided from the image providing unit 10. The preceding vehicle and the on-coming vehicle can be distinguished from each other by a difference in wavelength of light between a head lamp and a tail lamp, or a position of the central line shown in the image information. Particularly, the image information may include light generated from other light sources such as street lights and neon signs in addition to the head lamp or tail lamp. Accordingly, it is possible to identify the vehicle only by light between boundary points of the left and right roads in the image information. In addition, the head lamp or tail lamp is identified only when there is a pair of lights having similar illumination intensities and illumination patterns.

As described above, since the on-coming vehicle is moving while facing the subject vehicle, the on-coming vehicle may be more affected by the high beams of the subject vehicle. Accordingly, for example, if it is detected that the on-coming vehicle is within about 250 m from the subject vehicle, the high beam avoidance area E is calculated taking the on-coming vehicle into account. Further, after detecting whether there are preceding and/or on-coming vehicles ahead and the positions thereof, the angular range and the detailed information of the outermost vehicles are acquired based on the outermost vehicles on the left and right, and then may be taken into account in calculating the high beam avoidance area E.

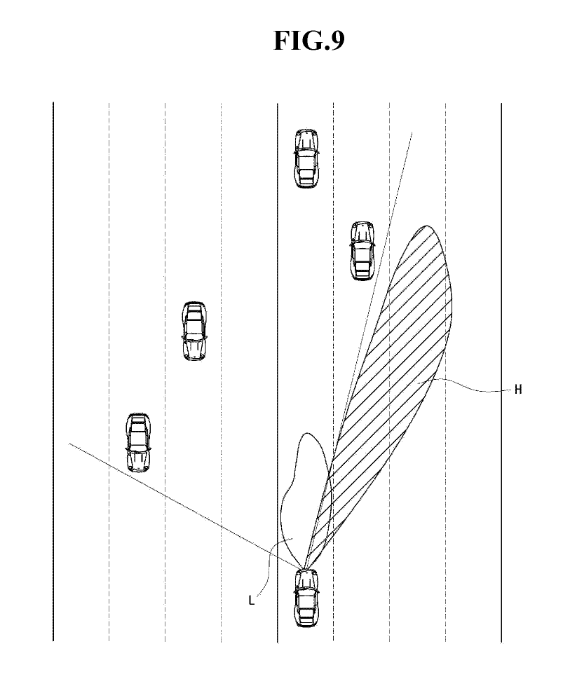

Subsequently, FIGS. 9 to 12 illustrate the high beam avoidance area and the high beam irradiation area of the apparatus for controlling a head lamp in various road situations in accordance with the embodiment of the present invention.

In a case of FIG. 9, since the on-coming vehicles are positioned adjacent to the subject vehicle, the whole left area with respect to the subject vehicle is set as the high beam avoidance area E. Further, since the preceding vehicles are positioned in the forward direction, the right area with respect to the subject vehicle has the high beam irradiation area H.

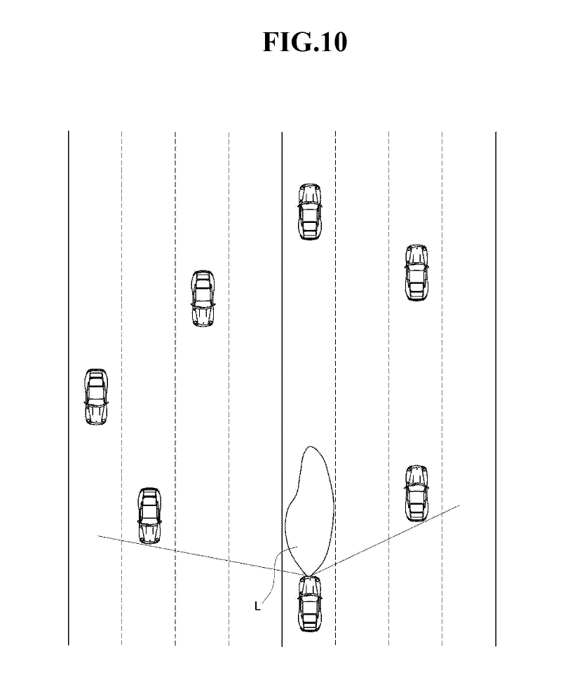

In a case of FIG. 10, since all of the on-coming vehicles and the preceding vehicles are positioned adjacent to the subject vehicle, the high beam avoidance area E is set in a very wide angular range, and the high beam irradiation area H is eliminated.

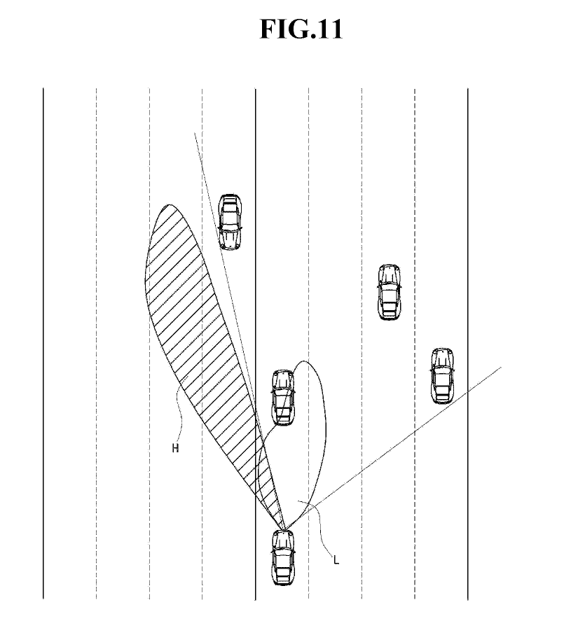

In a case of FIG. 11, since the preceding vehicles are positioned adjacent to the subject vehicle and in the rightmost lane, the high beam avoidance area E is set largely and the high beam irradiation area H is eliminated on the right side. On the other hand, since there is only one on-coming vehicle in the opposite lane immediately adjacent to the subject vehicle, the on-coming vehicle being separated from the subject vehicle by a predetermined distance, the high beam avoidance area E is set in a small angular range and the high beam irradiation area H is formed largely on the left side.

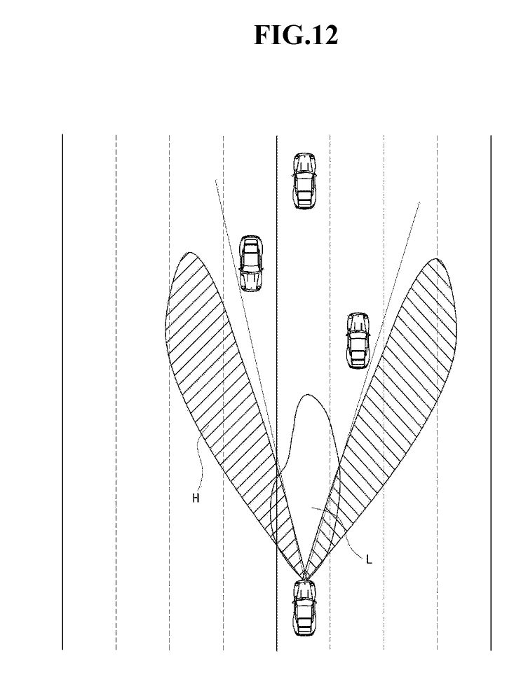

In a case of FIG. 12, there are all of the on-coming and preceding vehicles, but an angular range of the on-coming and preceding vehicles with respect to the subject vehicle is small. Accordingly, the high beam irradiation area H is formed on the left and right sides except for a central portion.

Subsequently, FIG. 13 illustrates the structure of the head lamp of the apparatus for controlling a head lamp in accordance with the embodiment of the present invention. As described above, the head lamp 30 includes the light source unit 31 which irradiates the high beam and the low beam in the head lamp 30, the light blocking unit 32 which blocks some or all of the high beam irradiated from the light source unit 31 to control the irradiation of the high beam, and the light blocking control unit 33 which determines a position of the light blocking unit 32 corresponding to the high beam avoidance area E. In addition, the head lamp 30 may include a reflective surface 34 surrounding the light source unit 31 to reflect light, and a condenser lens 35 arranged in a forward direction in a light traveling direction. Also, the head lamp 30 may selectively include a lens structure 36 positioned between the light source unit 31 and a lower portion of the reflective surface 34 to refract incident light toward the lower portion of the reflective surface 34. Further, in order to prevent the irradiation of the high beam to the high beam avoidance area E, a pair of the head lamps 30 may be individually swiveled in different directions and by different angles.

Some of light irradiated from the light source unit 31 is reflected by the reflective surface 34 and passes through the condenser lens 35 to be directed in a forward direction. Preferably, the condenser lens 35 may be configured as a convex lens, in which its rear surface (left surface in FIG. 13) is flat and its front surface (right surface in FIG. 13) is convex, in order to improve light efficiency. The lens structure 36 may refract incident light toward the lower portion of the reflective surface 34, thereby transmitting more light in a desired direction (forward direction) without loss of light. The lens structure 36 may have a plate shape having a large surface. As shown in FIG. 13, the lens structure 36 may have an optical functional part having a plurality of optical functional bodies such as prism ribs on its surface. More preferably, the lens structure 36 may be a Fresnel lens type structure.

The light blocking unit 32 is moved by the light blocking control unit (not shown) to block some or all of the high beam. Accordingly, the head lamp 30 may further include a driving force transfer unit (not shown) which transfers a driving force to the light blocking unit 32 to move the light blocking unit 32. The light blocking unit 32 may be slidable or rotatable in operation. The slidable light blocking unit 32, for example, may be configured to reciprocate in a horizontal direction or vertical direction of the head lamp 30.

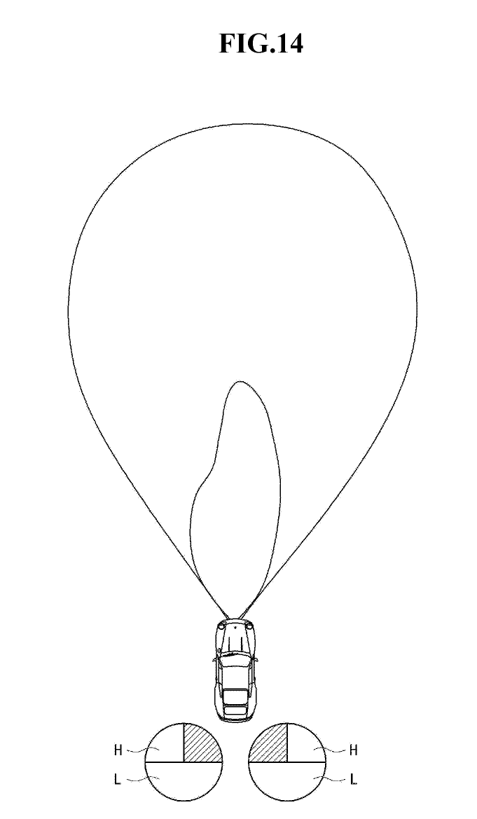

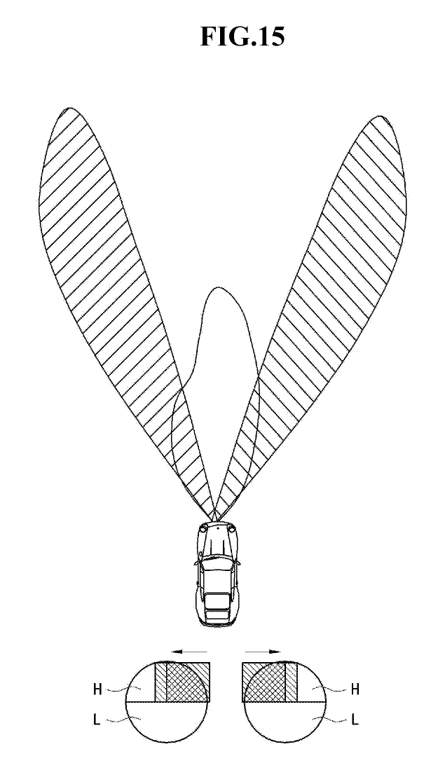

FIGS. 14 and 15 illustrate a high beam irradiation direction and irradiation area according to the position of the light blocking unit 32 of the apparatus for controlling a head lamp in accordance with the embodiment of the present invention. The irradiation range of the head lamp 30 is illustrated on the upper sides of FIGS. 14 and 15. The illumination pattern emitted from the head lamp 30 is conceptually divided into a plurality of areas in two circles on the lower sides of FIGS. 14 and 15, wherein a left circle represents the irradiation area of the left head lamp 30 of the subject vehicle and a right circle represents the irradiation area of the right head lamp 30 of the subject vehicle. In each circle, a lower semicircle represents the low beam L and an upper semicircle represents the high beam H.

FIG. 14 illustrates a state in which the light blocking unit 32 does not block the high beam. More specifically, a half area of the high beam area may be blocked to prevent the irradiation of light. In this case, since the high beam avoidance area E is not set, the high beam H is irradiated without limitation.

On the other hand, FIG. 15 illustrates a state in which the light blocking unit 32 is moved to block some of the high beam H. The light blocking unit 32 may gradually block the head lamp 30 from one end to the other end by the light blocking control unit 33. That is, in the left head lamp 30, the light blocking unit 32 is moved from right to left in FIG. 15 to block the high beam H. In the right head lamp 30, the light blocking unit 32 is moved from left to right in FIG. 15 to block the high beam H. The area of the high beam H blocked by the light blocking unit 32 corresponds to the high beam avoidance area E determined by the information processing unit 20.

Accordingly, the light blocking unit 32 blocks some of the high beam emitted from the light source unit 31, and controls such that the high beam is not irradiated to the high beam avoidance area E. Particularly, since the light blocking unit 32 is individually controlled for each head lamp 30, it is possible to control the high beam of each of the left and right head lamps 30.

As described above, in the apparatus for controlling a head lamp in accordance with the embodiment of the present invention, by analyzing the vehicle information in front of the subject vehicle when it is traveling with the high beams turned on, to the present invention automatically controls the high beam without any additional operation by the driver when there is a vehicle ahead, ether preceding or on-coming. Further, it is possible to ensure a maximum field of view of the subject vehicle by controlling the high beams so as not to disturb the vision of the driver of the preceding vehicle and/or the on-coming vehicle(s), thereby increasing driving safety.

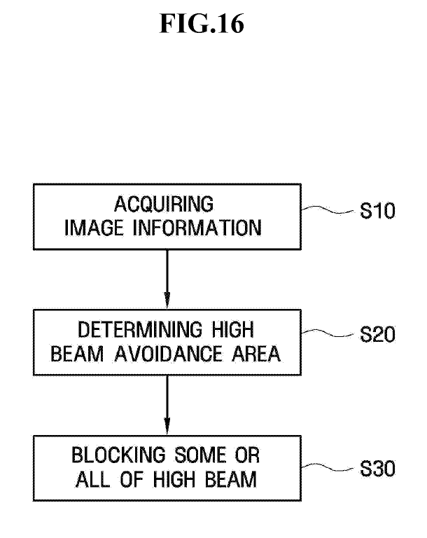

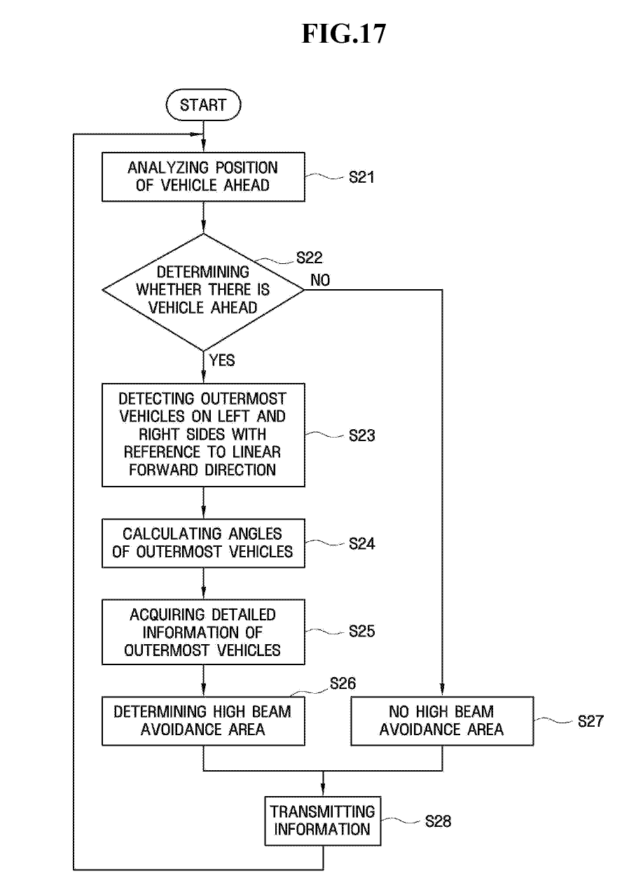

Hereinafter, a method for controlling a head lamp in accordance with the embodiment of the present invention will be described with reference to FIGS. 16 and 17. FIG. 16 illustrates a method for controlling a head lamp in accordance with the embodiment of the present invention. FIG. 17 is a flowchart showing a process of setting the high beam avoidance area in the method for controlling a head lamp in accordance with the embodiment of the present invention.

The method for controlling a head lamp in accordance with the embodiment of the present invention includes a step S10 of acquiring the image information in front of the subject vehicle through the camera module, a step S20 of determining the high beam avoidance area by detecting the position of the vehicle(s) in front of the subject vehicle based on the image information, and a step S30 of blocking some or all of the high beam in the head lamp corresponding to the high beam avoidance area.

As described above, in the method for controlling a head lamp in accordance with the embodiment of the present invention, the image information is acquired through the camera module, and it is determined whether there is the preceding vehicle and/or the operation vehicle and the position thereof based on the image information, thereby determining the high beam avoidance area. Then, the light blocking unit in the head lamp is moved so as not to irradiate the high beam to the high beam avoidance area, thereby blocking some or all of the high beam.

The method may further include a step of detecting driving information including a steering angle of the vehicle. The high beam avoidance area may be determined taking into account the driving information including a steering angle of the vehicle in addition to the image information. The head lamp may include first and second head lamps. The high beam avoidance area may be determined individually in each of the first head lamp and the second head lamp.

Further, the step of blocking some of the high beam may include moving the light blocking unit to a specific position. The light blocking unit may be moved by being slid or rotated. Particularly, in a case where the light blocking unit is provided rotatably, the light blocking unit may be protruded forward by being rotated. That is, the light blocking unit may be rotated around a rotational axis and protruded laterally to block the high beam instead of being directly slid to block the high beam as shown in FIG. 15.

A detailed flowchart of the step S20 of determining the high beam avoidance area is illustrated in FIG. 17.

First, the presence/absence and position of a vehicle ahead are analyzed based on the image information or the image information and the driving information (step S21). The image information used in the analysis may be the information as illustrated in FIG. 8. Based on the image information, it is determined whether there is a preceding vehicle and/or an on-coming vehicle in front of the subject vehicle (step S22). As described above, the high beam avoidance area is set only when it is determined that there is a preceding vehicle and/or an on-coming vehicle within a predetermined distance from the subject vehicle. Specifically, the predetermined distance may be set to be 150 m in case of the preceding vehicle and set to be 250 m in case of the on-coming vehicle. Accordingly, after determining whether there is a vehicle ahead, the high beam avoidance area is not set if there is no vehicle (step S27). On the other hand, if there is a vehicle, the outermost vehicles on the left and right with reference to a linear forward direction are detected and determined (step S23). That is, the high beam avoidance area is determined based on the outermost vehicles on the left and right, and may be represented by an angular range. The high beam avoidance area may be included in a range of 90 degrees on the left and right with reference to a forward direction of the subject vehicle. The presence of the outermost vehicles in the image information is determined by detecting light emitted from at least a pair of head lamps of the preceding vehicle positioned in front of the subject vehicle or light emitted from a pair of tails lamps of the on-coming vehicle. Then, the angles of the outermost vehicles are calculated (step S24), and the detailed information of the outermost vehicles is acquired (step S25). As described above, the detailed information may include dimension information such as widths of the outermost vehicles and distances to the outermost vehicles. The high beam avoidance area is determined based on a finally calculated angular range and the detailed information (step S26). The information regarding the determined high beam avoidance area is transmitted to the light blocking control unit in the head lamp (step S28).

The light blocking control unit appropriately moves the light blocking unit based on the information regarding the high beam avoidance area to block some or all of the high beam emitted from the light source unit, thereby automatically controlling the high beam.

In conclusion, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

It should be further noted that logic and control of the present invention may be embodied as computer readable media on a computer readable medium containing executable program instructions executed by a processor to control the apparatus of the illustrative embodiment of the present invention. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, for example, a CAN network.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling at least one head lamp of a vehicle, comprising:
an image providing unit configured to acquire image information in front of a subject vehicle through a camera module;
an information processing unit configured to detect a position of a vehicle in front of the subject vehicle based on the image information to determine a high beam avoidance area; and
a light source unit configured to irradiate a high beam and a low beam in the head lamp,
wherein the high beam avoidance area is represented by an angular range, and is within a range of 90 degrees with respect to a forward direction of the subject vehicle, and the angular range of the high beam avoidance area is determined based on outermost vehicles on left and right sides in the image information.

2. The apparatus of claim 1, wherein the light source unit is configured as a discharge bulb type or light emitting diode (LED) type light source.

3. The apparatus of claim 1, further comprising:
a light blocking unit configured to block at least some of the high beam light irradiated from the light source unit to control irradiation of the high beam; and
a light blocking control unit configured to determine a position of the light blocking unit corresponding to the high beam avoidance area.

4. The apparatus of claim 3, wherein the light blocking unit is slidable to block at least some of the high beam light according to the position of the light blocking unit.

5. The apparatus of claim 3, wherein the light blocking unit is rotatable to block at least some of the high beam light according to a rotation angle of the light blocking unit.

6. The apparatus of claim 1, wherein the head lamp includes first and second head lamps.

7. The apparatus of claim 6, wherein the high beam avoidance area is individually determined in each of the first and second head lamps.

8. The apparatus of claim 7, wherein the head lamps are individually swiveled.

9. The apparatus of claim 1, further comprising a driving information detection unit configured to detect driving information including a steering angle of the vehicle.

10. The apparatus of claim 9, wherein the high beam avoidance area is determined taking into consideration both of the image information and the driving information.

11. A method for controlling a head lamp for vehicles, comprising:
acquiring image information in front of a subject vehicle through a camera module;
determining a high beam avoidance area by detecting a position of a vehicle in front of the subject vehicle based on the image information; and
blocking at least some of a high beam light in the head lamp corresponding to the high beam avoidance area,
wherein the high beam avoidance area is represented by an angular range, and is within a range of 90 degrees with respect to a forward direction of the subject vehicle, and the angular range of the high beam avoidance area is determined based on outermost vehicles on left and right sides in the image information.

12. The method of claim 11, further comprising detecting driving information including a steering angle of the vehicle.

13. The method of claim 12, wherein said determining a high beam avoidance area comprises determining the high beam avoidance area taking into consideration both of the image information and the driving information.

14. The method of claim 11, wherein the head lamp includes first and second head lamps.

15. The method of claim 14, wherein the high beam avoidance area is individually determined in each of the first and second head lamps.

16. The method of claim 11, wherein the high beam is irradiated by a discharge bulb type or LED type light source.

17. The method of claim 11, wherein said blocking at least some of a high beam light comprises moving a light blocking unit to a specific position.

18. The method of claim 17, wherein the light blocking unit is slidable.

19. The method of claim 17, wherein the light blocking unit is rotatable.

20. An apparatus for controlling at least one head lamp of a vehicle, comprising:
a first unit configured to acquire image information in front of a subject vehicle through a camera module;
a second unit configured to detect a position of a vehicle in front of the subject vehicle based on the image information to determine a high beam avoidance area; and
a third unit configured to irradiate a high beam and a low beam in the head lamp.

21. The apparatus of claim 20 wherein the high beam avoidance area is represented by an angular range, and is within a range of 90 degrees with respect to a forward direction of the subject vehicle, and the angular range of the high beam avoidance area is determined based on outermost vehicles on left and right sides in the image information.

22. A computer readable medium containing executable program instructions executed by a processor, comprising:
program instructions that acquire image information in front of a subject vehicle through a camera module;
program instructions that determine a high beam avoidance area by detecting a position of a vehicle in front of the subject vehicle based on the image information; and
program instructions that control an apparatus to block at least some of a high beam light in the head lamp corresponding to the high beam avoidance area based on the driving information acquired,
wherein the high beam avoidance area is represented by an angular range, and is within a range of 90 degrees with respect to a forward direction of the subject vehicle, and the angular range of the high beam avoidance area is determined based on outermost vehicles on left and right sides in the image information.
